(19) United States
(12) Patent Application Publication
(10) Pub. No.: US 2009/0191424 A1
(43) Pub. Date: Jul. 30, 2009

(54) MANUFACTURING METHOD FOR A COMPOSITE METAL WIRE USED AS A PACKAGING WIRE AND PRODUCTS THEREOF

(76) Inventor: Jun-Der LEE, Tao-Yuan Hsieng (TW)

Correspondence Address: HDLS Patent & Trademark Services, P.O. BOX 220746, CHANTILLY, VA, 20153-0746, US

(21) Appl. No.: 12/020,835

(22) Filed: Jan. 28, 2008

(51) Int. Cl. B32B 15/01; B21D 31/00

(52) U.S. Cl. 428/672; 72/377

(57) ABSTRACT

A manufacturing method for a composite metal wire used as semiconductor packaging wire and products thereof. Au, Ag and Cu materials are melted in a vacuum melting furnace, and then trace metal elements are added into the vacuum melting furnace and melted together with Au, Ag and Cu materials to obtain a composite material. The obtained composite material is drawn by a fist thick drawing machine, a second thick drawing machine and a first thin drawing machine to obtain a composite metal wire with a predetermined diameter. An Au layer is electroplated to the surface of the composite metal wire. The composite metal wire with Au layer is then drawn by a thin drawing machine, a very thin drawing machine and an ultra thin drawing machine to obtain an ultra thin composite metal wire with a predetermined diameter. Finally, the surface of the composite metal wire is washed and the composite metal wire is heat treated to ensure a final product with desirable physical properties, e.g. breaking load and elongation.

### BACKGROUND OF THE INVENTION

1. Field of the Invention

The present invention generally relates to a metal wire, in particular, to a manufacturing method for a composite metal wire and products thereof.

2. Description of Prior Art

In conventional semiconductor packaging processes for IC, LED, SAW., a chip is fixed on the substrate and then a wire bonding process is performed to connect each bonding pad of the chip to the substrate. It is therefore very important to select a proper bonding wire and bonding technique for a semiconductor packaging process.

The selection of a bonding wire with proper physical properties and diameter, and the parameters setting for the wire bonding process are based on the characteristics of the chosen semiconductor packaging process. The main physical properties of a bonding wire, such as breaking load, elongation, loop, melting point, are dependent on the selected material for bonding wire. The selection of bonding wire material has a lot to do with the wire bonding process, life cycle and stability of the packaged semiconductor device. Therefore, the wire bonding material selected for a semiconductor packaging process is usually featured by its high elongation property and stability.

The two bonding wires usually selected for conventional semiconductor packaging processes are pure Au bonding wire and Al—Si bonding wire. Pure Au bonding wire has been widely used in semiconductor packaging process because of its physical properties, e.g. elongation and electrical conductivity. However, pure Au bonding wire inevitably leads to high cost. Therefore, the purpose of the present invention is to provide a lost cost bonding wire with performance comparable to pure Au bonding wire.

### SUMMARY OF THE INVENTION

The invention is mainly to provide a low cost composite metal wire used as a bonding wire with performance as good as a pure Au bonding wire.

In order to obtain the purpose mentioned above, a manufacturing method for a composite metal wire used as semiconductor packaging wire and products thereof. Au, Ag, Cu materials are melted in a vacuum melting furnace, and then trace metal elements are added into the vacuum melting furnace and melted together with Au, Ag, Cu materials to obtain a composite material. The obtained composite material is drawn by a continneous casting machine and the first thick drawing machine, the second thick drawing machine and the first thin drawing machine to obtain a composite metal wire with a predetermined diameter. A Ni layer is electroplated to the surface of the composite metal wire and the Ni surface is washed if the Ni layer is requested by customer. An Au layer is subsequently electroplated to the surface of the Ni layer, then the Au surface is washed and dried. If the Ni layer is not requested, the Au layer is directly electroplated to the surface of the composite metal wire, then the Au layer is washed and dried.

After completion of the electroplating process, composite metal wire with Au layer is then drawn by the first thin drawing machine, a very thin drawing machine and an ultra thin drawing machine to obtain an ultra thin composite metal wire with a predetermined diameter. Finally, the surface of the composite metal wire is washed and the composite metal wire is heat treated to ensure a final product with desirable physical properties, e.g. breaking load and elongation.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a flow chart for manufacturing composite metal wire of the present invention;

FIG. 2 is a detailed flow chart of FIG. 1;

FIG. 3 is a flow chart for the electroplating process of the present invention;

FIG. 4 is a cross sectional diagram of the composite metal wire of the present invention; and

FIG. 5 is a cross sectional diagram of another composite metal wire of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

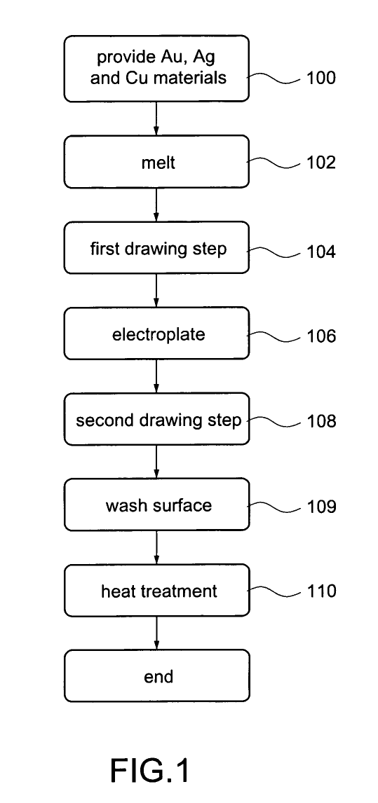

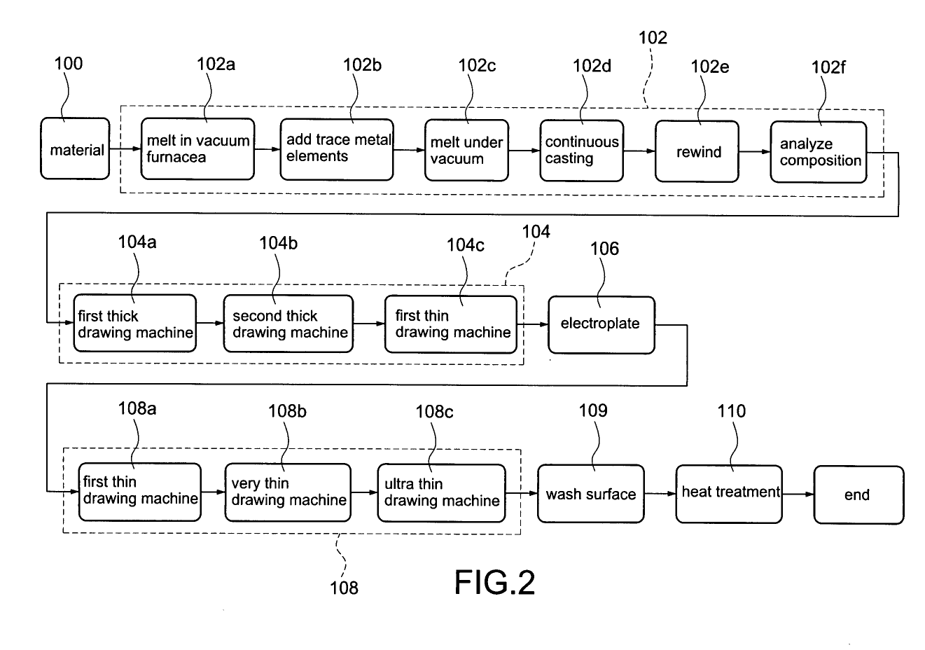

Please refer to FIG. 1 and FIG. 2, which respectively are a flow chart for manufacturing composite metal wire of the present invention and a detailed flow chart of FIG. 1. Step 100, a material with 90.00˜99.99% Ag, 0.0001˜10.00% Au, 0.0001˜10.00% Cu is provided.

Step 102, Au, Ag and Cu are melted in a vacuum melting furnace (step 102a). Specific amounts of trace metal elements Be and Al, e.g. 0.0001˜3.00% Be and 0.0001˜1.00% Al are added into the vacuum melting furnace (step 102b), and melted together with Au, Ag and Cu under vacuum in the vacuum melting furnace (step 102c) to obtain a composite metal alloy AuₜAg_{w}CuₓBe_{y}Al_{z}. Subsequently, continuous casting process (drawing) (step 102d) is performed on the composite metal alloy to obtain a composite metal wire with diameter 4-8 mm. The composite metal wire is rewinded by a reeling machine (step 102e) and then composition analysis (102f) is performed on the composite metal wire to check if the obtained composition meets the requirement.

Step 104, a first drawing step is processed, so the obtained composite metal wire with diameter 4-8 mm is drawn by a first thick drawing machine (step 104a) to obtain a composite metal wire with a predetermined diameter 3 mm or smaller than 3 mm. The composite metal wire with diameter 3 mm or smaller than 3 mm is drawn by a second thick drawing machine (step 104b) to obtain a composite metal wire with a predetermined diameter 1 mm or smaller than 1 mm. The composite metal wire with diameter 1 mm or smaller than 1 mm is drawn by a first thin drawing machine (step 104c) to obtain a composite metal wire with a predetermined diameter 0.5 mm or smaller than 0.5 mm.

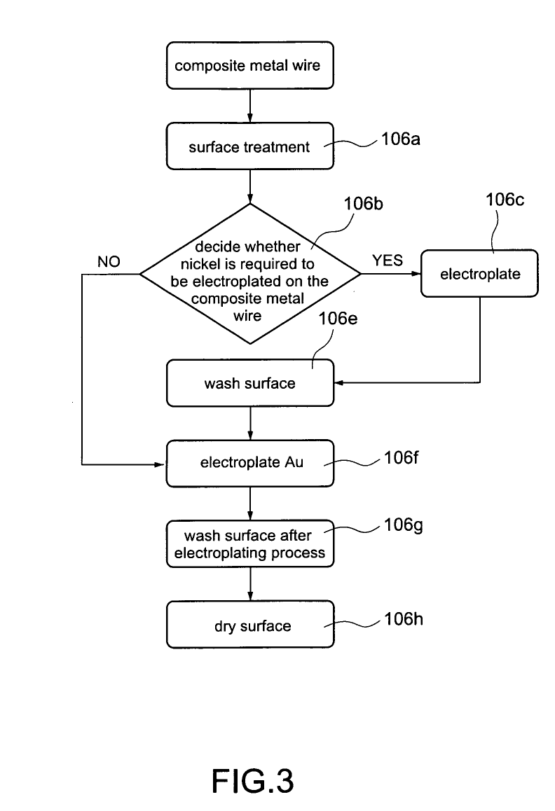

Step 106, an electroplating process is performed on the composite metal wire. As shown in FIG. 3, a surface treatment is performed on the composite metal wire (step 106a), then decide whether Ni is required to be electroplated on the composite metal wire (step 106b) by request of customer. If Ni is required, a Ni layer is electroplated on the composite metal wire (106c), then the obtained Ni surface is washed (step 106e). An Au layer is subsequently electroplated to the surface of the Ni layer (step 106f) to prevent composite metal wire surface from oxidation and corrosion, then the Au surface is washed (step 106g) and dried (step 106h). If the Ni layer is not required (decided in step 106b), a 0.10˜3.00 μm thick Au layer is directly electroplated to the surface of the composite metal wire, then the Au layer is washed (step 106g) and dried (step 106h).

Step 108, after completion of the electroplating process, a second drawing step is performed, the composite metal wire with Au layer is then drawn by the first thin drawing machine (step 108a), a very thin drawing machine (step 108b) and an ultra thin drawing machine (step 108c) to obtain an ultra thin composite metal wire with a predetermined diameter (e.g. 0.0508 mm (2.00 mil) or 0.0254 (1.00 mil)).

Step 109, composite metal wire surface is washed.

Step 110, the composite metal wire is heat treated to ensure a final product with desirable physical properties, e.g. breaking load and elongation.

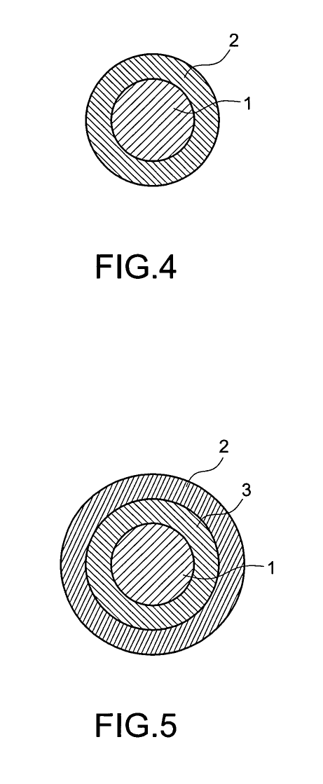

Refer to FIG. 4. FIG. 4 is a cross sectional diagram of the composite metal wire of the present invention. The obtained composite metal wire according to the present invention includes a composite metal wire 1 and an Au layer 2, wherein, the composite metal wire consists of 90.009˜9.99% Ag, 0.0001˜10.00% Au and 0.0001˜10.00% Cu as major components, and 0.0001˜3.00% trace metal element Be and 0.0001˜1.00% trace metal element Al are added as the minor components.

The Au layer 2 is formed by electroplating a Ni layer to the surface of the composite metal wire 1.

The composite metal wire 1 with the Au layer 2 can be applied to packaging process of IC, LED and SAW.

Refer to FIG. 5, FIG. 5 is a cross sectional diagram of another composite metal wire of the present invention. The structural difference shown between FIG. 4 and FIG. 5 is a Ni layer exists between the composite metal wire 1 and the Au layer 2 in FIG. 5. The Ni layer 3 is formed on the surface of the composite metal wire 1, and then the Au layer 2 is formed on the surface of the Ni layer 3. The obtained composite metal wire with the Ni layer 3 and the Au layer 2 can be applied to packaging process of IC, LED and SAW.

What is claimed is:

1. A manufacturing method for a composite metal wire used as a packaging wire, including:
a) providing material with Au, Ag and Cu;
b) melting the material in a vacuum melting furnace, adding predetermined amounts of trace metal elements Be and Al into the vacuum melting furnace and melting together with Au, Ag and Cu under vacuum in the vacuum melting furnace to obtain a composite metal alloy, the composite metal alloy being drawn to the composite metal wire by:
c) performing a first drawing step on the composite metal wire to obtain a composite metal wire with a first predetermined diameter;
d) performing at least an electroplating process to have a metal layer electroplated to the surface of the composite metal wire with the first predetermined diameter; and
e) performing a second drawing step on the composite metal wire with the first predetermined diameter to obtain a composite metal wire with a second predetermined diameter after completion of the electroplating process.

2. The manufacturing method according to claim 1, wherein the mass fraction of Ag in step
a) is 90.00%˜99.99%.

3. The manufacturing method according to claim 1, wherein the mass fraction of Au in step
a) is 0.0001%˜10.00%.

4. The manufacturing method according to claim 1, wherein the mass fraction of Cu in step a) is 0.0001%˜10.00%.

5. The manufacturing method according to claim 1, wherein the mass fraction of the trace metal element Be in step b) is 0.0001%˜3.00%.

6. The manufacturing method for a composite metal wire used as a packaging wire according to claim 1, wherein the mass fraction of the trace metal element Al in step b) is 0.0001%˜1.00%.

7. The manufacturing method according to claim 1, wherein a continuous casting process (drawing) is performed on the composite metal alloy in step b) to obtain the composite metal wire with diameter 4-8 mm, the composite metal wire is rewinded by a reeling machine and then a composition analysis is performed on the composite metal wire to check if the composition meets the requirement.

8. The manufacturing method according to claim 1, wherein the first drawing step in step c) is to have the composite metal wire drawn by a first thick drawing machine to obtain the composite metal wire with a predetermined diameter 3 mm or smaller than 3 mm, the composite metal wire with diameter 3 mm or smaller than 3 mm is drawn by a second thick drawing machine to obtain a composite metal wire with a predetermined diameter 1 mm or smaller than 1 mm, the composite metal wire with diameter 1 mm or smaller than 1 mm is drawn by a first thin drawing machine to obtain a composite metal wire with a predetermined diameter 0.5 mm or smaller than 0.5 mm.

9. The manufacturing method according to claim 1, wherein the electroplating process in step d) includes:
performing a surface treatment on the composite metal wire;
electroplating a Ni layer on the composite metal wire;
washing the obtained Ni surface; and
electroplating an Au layer to the surface of the Ni layer.

10. The manufacturing method according to claim 9, wherein the thickness of the Au layer is 0.10˜3.00 μm.

11. The manufacturing method according to claim 1, wherein the electroplating process in step d) includes:
performing a surface treatment on the composite metal wire;
electroplating an Au layer on the composite metal wire;
washing the obtained Au surface; and
drying the Au layer surface.

12. The manufacturing method according to claim 11, wherein the thickness of the Au layer is 0.10˜3.00 μm.

13. The manufacturing method according to claim 1, wherein the second drawing step in step e) is to have the composite metal wire drawn by a first thin drawing machine, a very thin drawing machine and an ultra thin drawing machine to obtain an ultra thin composite metal wire with a predetermined diameter 0.0508 mm (2.00 mil)˜17.78 (0.07 mil).

14. The manufacturing method according to claim 1, wherein the surface of the composite metal wire is cleaned and the composite metal wire is heat treated after step e).

15. A composite metal wire product used as a packaging wire, including:
a composite metal wire; and
an Au layer coated on the surface of the composite metal wire.

16. The composite metal wire product according to claim 15, wherein the composite metal wire consists of 90.00˜99.99% Ag, 0.0001˜10.00% Au, 0.0001˜10.00% Cu as major components.

17. The composite metal wire product according to claim 16, wherein the composite metal wire consists of 0.0001˜3.00% trace metal element Be and 0.0001˜1.00% trace metal element Al.

18. The composite metal wire product used as a packaging wire according to claim 15, wherein the thickness of the Au layer is 0.10˜3.00 μm.

19. A composite metal wire product used as a packaging wire, including:
a composite metal wire;
a Ni layer coated on the surface of the composite metal wire; and
an Au layer coated on the Ni layer.

20. The composite metal wire product according to claim 19, wherein the composite metal wire consists of 90.00˜99.99% Ag, 0.0001˜10.00% Au, 0.0001˜10.00% Cu as major components.

21. The composite metal wire product used as a packaging wire according to claim 20, wherein the composite metal wire consists of 0.0001˜3.00% trace metal element Be and 0.0001˜1.00% trace metal element Al.

22. The composite metal wire product according to claim 20, wherein the thickness of the Au layer is 0.10˜3.00 μm.
